(19) United States
(12) Patent Application Publication
(10) Pub. No.: US 2006/0205386 A1
(43) Pub. Date: Sep. 14, 2006

(54) Method and apparatus for providing encryption and integrity key set-up

(76) Inventors: Lei Yu, San Diego, CA (US); Naveen Kalla, San Diego, CA (US)

Correspondence Address: DITTHAVONG & CARLSON, P.C., Suite A, 10507 Braddock Road, Fairfax, VA, 22032, US

(21) Appl. No.: 11/077,637

(22) Filed: Mar. 11, 2005

(51) Int. Cl. H04M 1/66

(52) U.S. Cl. 455/411; 455/410

(57) ABSTRACT

An approach is provided for communication signaling. Update of shared secret data is initiated with a mobile station. A random value associated with authentication of the mobile station is received. A key is generated based on the updated shared secret data and the random value. Set-up of the key and crypto-sync exchange is then executed with the mobile station. The above process is particularly suitable for deployment in radio communication systems, such as a cellular system.

### FIELD OF THE INVENTION

The present invention relates to communications, and more particularly, to providing secure communications.

### BACKGROUND OF THE INVENTION

Radio communication systems provide users with the convenience of mobility along with a rich set of services and features. With the vast and rapid adoption of these services, security concerns become paramount. Accordingly, these efforts have concentrated in ensuring secure communications. Unfortunately, standardization can lag behind technological advancements, as extant standards can result in inefficient and inflexible network operation.

Notably, authentication procedures play an important role in communicating in a secure environment, particularly when the environment is a radio communication system, such as a cellular network. Authentication is the process by which information is exchanged between a mobile station and base station for the purpose of confirming the identity of the mobile station. A successful outcome of the authentication process occurs only when it can be demonstrated that the mobile station and base station possess identical sets of shared secret data (SSD).

For example, in the IS2000 standard, the 2G (2^{nd} Generation) keys used for encryption and integrity protection are generated from the SSD. At the end of the SSD update procedure, both mobile station and base station have the same SSD.

It is recognized, however, that the traditional SSD update mechanism fails to efficiently support set up of new keys and crypto-sync. Crypto-sync provides synchronizing information for cryptoalgorithms (ciphers) that allows an encryptor and a decryptor resident at different stations to properly decrypt ciphertext.

Therefore, there is a need to accommodate both the SSD update process and the process for generating a new set of encryption/integrity keys and crypto-sync.

### SUMMARY OF THE INVENTION

These and other needs are addressed by the present invention, in which an approach provides a new set of encryption/integrity keys and crypto-sync.

According to one aspect of an embodiment of the present invention, a method for providing communication signaling is disclosed. The method includes initiating update of shared secret data with a mobile station; and receiving, from the mobile station, a random value associated with authentication of the mobile station. The method also includes generating a key based on the updated shared secret data and the random value. Further, the method includes performing set-up of the key and crypto-sync exchange with the mobile station.

According to another aspect of an embodiment of the present invention, an apparatus for providing communication signaling is disclosed. The apparatus includes means for initiating update of shared secret data with a mobile station; and means for receiving, from the mobile station, a random value associated with authentication of the mobile station. Also, the apparatus includes means for generating a key based on the updated shared secret data and the random value; and means for performing set-up of the key and crypto-sync exchange with the mobile station.

According to another aspect of an embodiment of the present invention, a method for providing communication signaling is disclosed. The method includes receiving a request from a base station for updating of shared secret data; and transmitting a random value for authentication to the base station. The method also includes generating a key based on the updated shared secret data and the random value. Further, the method includes performing set-up of the key and crypto-sync exchange with the base station.

According to another aspect of an embodiment of the present invention, an apparatus for providing communication signaling is disclosed. The apparatus includes means for receiving a request from a base station for updating of shared secret data; and means for transmitting a random value for authentication to the base station. The apparatus also includes means for generating a key based on the updated shared secret data and the random value. Further, the apparatus includes means for performing set-up of the key and crypto-sync exchange with the base station.

According to another aspect of an embodiment of the present invention, a method of providing secure communications is disclosed. The method includes communicating with a base station to update shared secret data (SSD). The communicating step includes receiving a SSD update message from the base station, transmitting a base station challenge order to the base station, receiving a base station challenge confirmation order from the base station, and transmitting a SSD update confirmation order to the base station. Additionally, the method includes generating a cellular message encryption algorithm key (CMEAKEY) based on the updated shared secret data and a base station random variable (RANDBS). The base station generates the CMEAKEY based on the updated shared secret data and the RANDBS; the RANDBS is conveyed by the base station challenge order. In addition, the method includes transmitting, to the base station, a security mode request message specifying a crypto-sync and an authentication response (AUTHR), wherein the base station verifies the authentication response generated by the mobile station and commits to the CMEAKEY and the crypto-sync. Further, the method includes receiving a security mode command message instructing commitment to the CMEAKEY and the crypto-sync in response to the security mode request message.

According to another aspect of an embodiment of the present invention, a method of providing secure communications is disclosed. The method includes receiving a shared secret data (SSD) update message from a base station for updating of shared secret data. The method also includes selecting a base station random variable (RANDBS) and generating a cellular message encryption algorithm key (CMEAKEY) based on the updated shared secret data and the RANDBS. The method also includes transmitting to the base station a base station challenge order specifying the RANDBS and a crypto-sync to the base station, wherein the base station generates the CMEAKEY based on the updated shared secret data and the RANDBS. Additionally, the method includes receiving, in response to the base station challenge order, a base station challenge confirmation order specifying a base station authorization response (AUTHBS) to confirm validity of the update of the SSD. Further, the method includes committing to the CMEAKEY and the crypto-sync; and transmitting an SSD update confirmation order to the base station to indicate successful update of the shared secret data, wherein the base station commits to the CMEAKEY and the crypto-sync.

According to another aspect of an embodiment of the present invention, a base station includes a memory configured to store shared secret data. The base station also includes a processor configured to initiate update of the shared secret data with a handset. Further, the base station includes a communication interface coupled to the processor and configured to receive, from the handset, a random value associated with authentication of the handset. The processor is further configured to generate a key based on the updated shared secret data and the random value, the processor performing set-up of the key and crypto-sync exchange with the handset.

According to yet another aspect of an embodiment of the present invention, a handset includes a memory configured to store shared secret data. The handset also includes a communication interface configured to receive a request from a base station for updating of the shared secret data. Further, the handset includes a processor configured to generate a random value for authentication, wherein the communication interface transmits the random value to the base station. The processor generates a key based on the updated shared secret data and the random value, and performs set-up of the key and crypto-sync exchange with the base station.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a radio communication system capable of providing key set-up and crypto-sync exchange, in accordance with an embodiment of the present invention;

FIG. 2 is a diagram of a key set-up and crypto-sync exchange process between a base station and a mobile station in the system of FIG. 1;

FIGS. 3 and 4 are diagrams of two alternative processes for generating new keys and crypto-sync based on a new Shared Secret Data (SSD), in accordance with various embodiments of the present invention; and

FIG. 5 is a diagram of hardware that can be used to implement an embodiment of the present invention.

### DESCRIPTION OF THE PREFERRED EMBODIMENT

An apparatus, method, and software for supporting key and crypto-sync based on an updated shared secret data (SSD) are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the present invention is discussed with respect to a spread spectrum system, it is recognized by one of ordinary skill in the art that the present invention has applicability to any type of radio communication system.

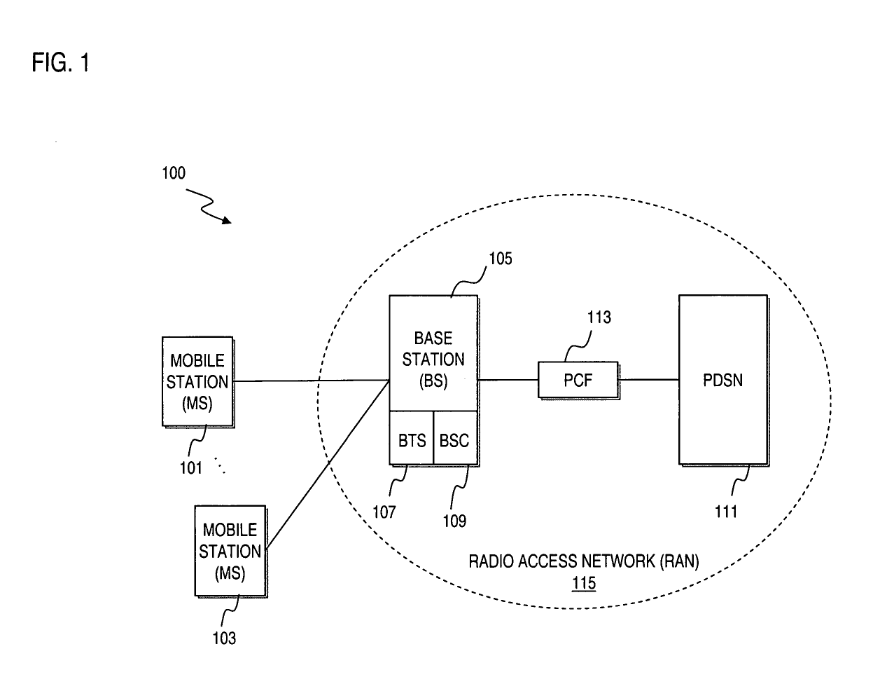

FIG. 1 is a diagram of a radio communication system capable of providing key set-up and crypto-sync exchange, in accordance with an embodiment of the present invention. A radio network 100 includes Mobile Stations (MS) 101, 103 in communication with a Base Station (BS) 105. In an exemplary embodiment, the mobile stations 101, 103 are handsets or other equivalent handheld communication devices. Authentication procedures are conducted among the mobile stations 101, 103 and the base station 105 to identify the mobile stations 101, 103, thereby ensuring that such stations 101, 103 are properly authorized to utilize the resources of the network 100. To facilitate this identification, the MSs 101, 103 store shared secret data (SSD) that is known to the BS 105.

By way of example, a SSD is partitioned into two distinct subsets. Each subset is used to support a different process.

TABLE 1

| Content | Length | Description |
|---|---|---|
| SSD_A | 64 bits | Support the authentication |
| | | procedures |
| SSD_B | 64 bits | Support voice privacy |

SSD_A is used to support the authentication procedures and SSD_B is used to support voice privacy and message encryption. In an exemplary embodiment, the SSD is a 128-bit quantity that is stored in semi-permanent memory in the mobile station (e.g., MS 101) and is readily available to the base station 105.

The mobile station 101 also maintains a 32-bit random value (RAND). RAND is used in conjunction with SSD_A and other parameters, as appropriate, to authenticate mobile station originations, terminations and registrations.

The SSD is updated using a SSD generation (SSD_Generation) procedure, initialized with mobile station specific information, random data, and the mobile station's A-key (which can be 64 bits in length). The A-key is assigned to the mobile station 101 and is stored in the mobile station's permanent security and identification memory. The A-key is known only to the mobile station and to its associated Home Location Register/Authentication Center (HLR/AC). The SSD update and generation procedures are further detailed in IS2000 Revision D standard, entitled “Upper Layer (Layer 3) Signaling Standard for cdma2000 Spread Spectrum Systems,” which is incorporated herein in its entirety.

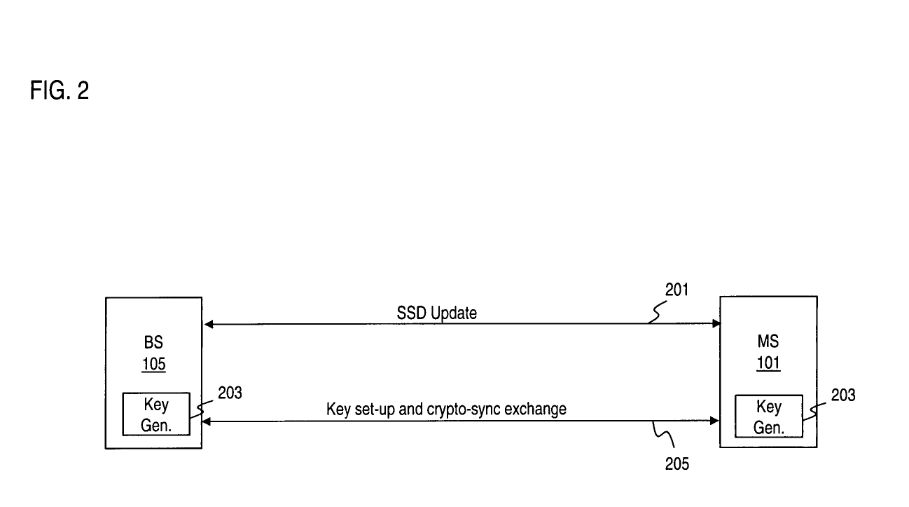

Unlike traditional systems, the base station 105 and the mobile station 101 output a set of encryption/integrity key based of newly generated Shared Secret Data (SSD), and a new crypto-sync will be set up between the mobile station (e.g., 101 and 103) and the base station 105. The process is more fully detailed below in FIGS. 2-4.

According to one embodiment of the present invention, the radio network 100 supports Second and Third Generation (2G and 3G) services as defined by the International Telecommunications Union (ITU) for International Mobile Telecommunications 2000 (IMT-2000). For the purposes of explanation, the carrier and channel selection capability of the radio network 100 is explained with respect to a cdma2000 architecture. As the third-generation version of IS-95, cdma2000 is being standardized in the Third Generation Partnership Project 2 (3GPP2).

In this example, the base station 105 includes a Base Transceiver Station (BTS) 107 and Base Station Controller (BSC) 109. Although a single BTS 107 is shown, it is recognized that multiple BTSs are typically are connected to the BSC 109 through, for example, point-to-point links. The BS 105 can be linked to a Packet Data Serving Node (PDSN) 111 through a Packet Control Function (PCF) 113. The PCF 113 is largely responsible for directing Point-to-Point Protocol (PPP) connection requests from the MS 101 to the PDSN 111. The BS 105, PCF 113, and PSDN 111 constitute the Radio Access Network (RAN) 115.

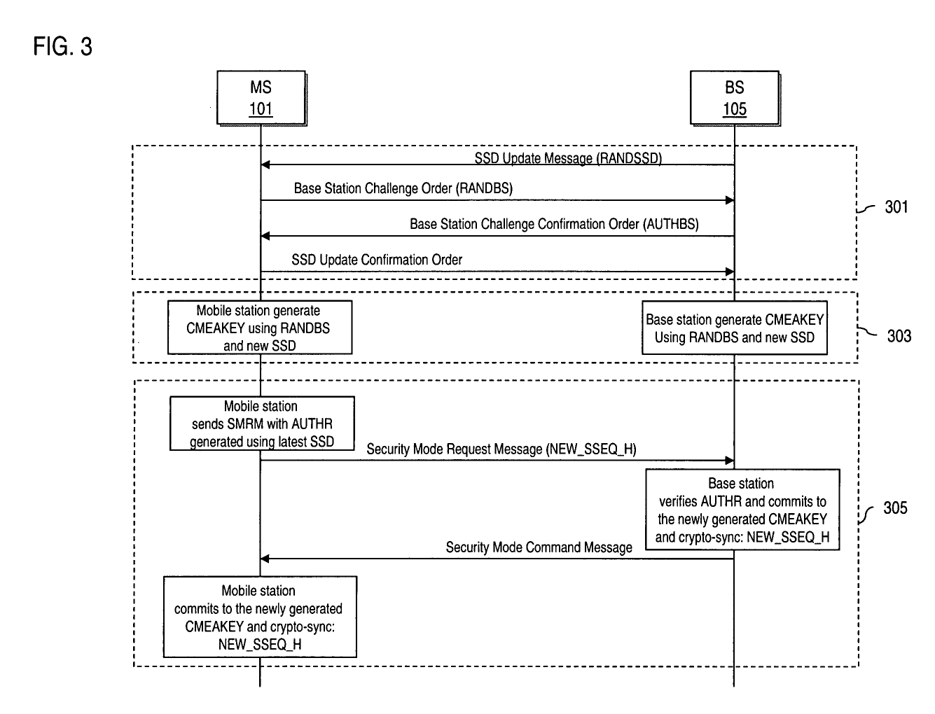

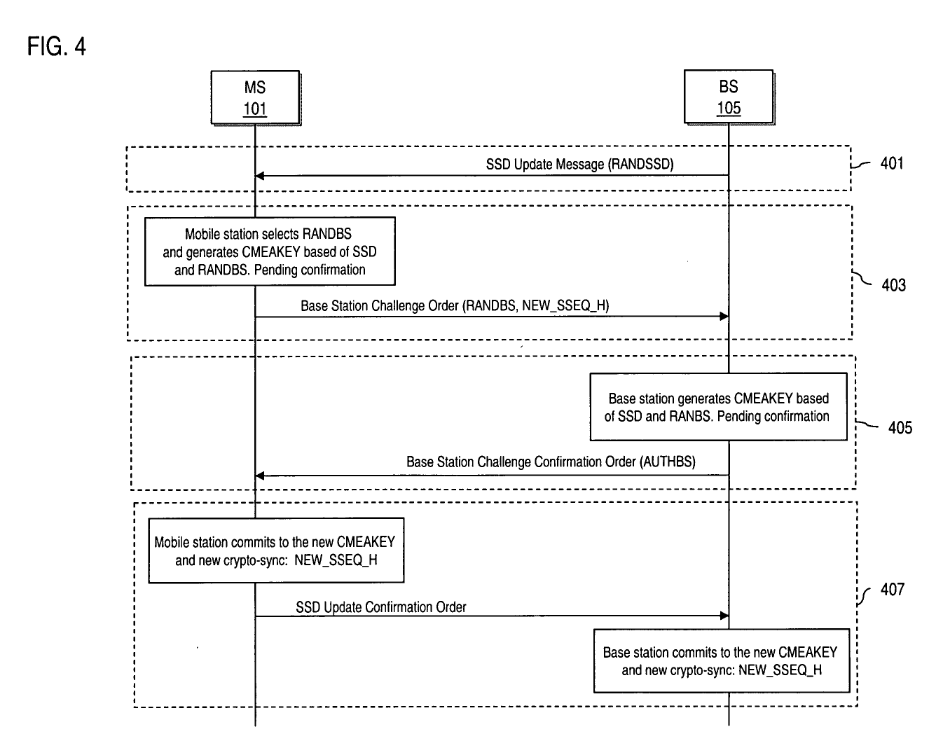

FIG. 2 is a diagram of a key set-up and crypto-sync exchange process between a base station 105 and a mobile station 101 in the system of FIG. 1. In step 201, the SSD update procedure is executed between the base station 105 and the mobile station 101. Next, the stations generate keys according to the updated SSD, per step 203. In step 205, the key set-up and crypto-sync exchange is performed. This process can be implemented according to the procedures of FIG. 3 or FIG. 4.

Conventionally, once the SSD Update procedure is finished, there is no procedure defined for mobile station 101 and base station 105 to set up a new set of keys and crypto-sync based of the newly acquired SSD. In order to set up new keys and crypto-sync, the mobile station 101 has to send a multitude of other messages, Registration Message/Origination Message/Page Response Message (ROP), and wait for Registration Accepted Order/Extended Channel Assignment Message/Security Mode Command Message (RES). This procedure is extremely inefficient.

Before any message integrity or extended encryption can be performed, the mobile station 101 and base station 101 are required to securely set up the same set of integrity key, encryption key, and security sequence number. By way of example, two types of authentication procedures, 2G authentication and 3G authentication, can be used. Accordingly, there are two types of keys that the base station 105 could obtain from the network 115—the CMEAKEY (Cellular Message Encryption Algorithm Key) or the (IK, CK) pair. The CMEAKEY is generated using CAVE during 2G authentication as described in the IS2000 Revision D standard. The (IK, CK) pair is a result of 3G authentication. In the 3G authentication, the mobile station 101 uses IK as the integrity key and CK as the encryption key—referred to as the (IK, CK) pair. Whenever an idle mobile station 101 does not have any integrity key and encryption key to use, it starts the 2G authentication and key set-up procedures by registering via a ROP.

The ROP specifies a new key id (NEW_KEY_ID) and a new security sequence number, crypto-sync, (NEW_SSEQ_H) associated with the Authorization Response (AUTHR) of the message. The mobile station 101 also starts a Key Set-Up timer. If for any reason the keys cannot be established before the timer expires, the mobile station 101 enters the System Determination Substate with an encryption/message integrity failure indication upon the expiration of the timer, which triggers re-registrations. If after several attempts of re-registrations such that the integrity key and encryption key still cannot be established, the mobile station 101 may reject the serving base station 105, and the base station 105 may reject serving the mobile station 101.

If the authentication is successful, when the CMEAKEY is available at the base station 105, the base station 105 uses assured mode to send a RES that includes a Message Authentication Code generated using the pending CIK, and the pending NEW_SSEQ_H (proposed by the mobile station). Upon reception of the RES, the mobile station 101 validates a MACI—which is a 32-bit LAC (Link Access Control) Layer field that carries either the MAC-I (Message Authentication Code for message integrity) or the UMAC (output of the UMAC algorithm computed by User Identity Module (UIM) based on MAC-I) of a signaling message.

The SSD update procedure can be initiated by the base station 105 at any time (e.g., while mobile station 101 is in idle or in traffic state) to update the mobile station's SSD. However, depending on whether the SSD update happens in traffic or idle state, the traditional SSD update process handles these two states differently. In the idle state, after SSD update, the mobile station 101 needs to start key set-up procedure by sending ROP and wait for RES. In the traffic state, after SSD update, the mobile station 101 has to wait until the end of the call and starts key set-up procedure in the idle state. In other words, if the SSD update occurs while mobile station 101 is in traffic state, the mobile station 101 has to wait for the current call to end and for a key set-up procedure to start using ROP in the idle state, which can pose security risk.

FIGS. 3 and 4 are diagrams of two alternative processes for generating new keys and crypto-sync based on a new Shared Secret Data (SSD), in accordance with various embodiments of the present invention. In step 301, a conventional SSD Update procedure can be utilized. Specifically, the base station 105 transmits an SSD Update Message to mobile station 101. The SSD Update Message includes a RANDSSD field that specifies the same random value used for the Home Location Register/Authentication Center HLR/AC computation of SSD. The mobile station 101 next performs the SSD_Generation procedure, and sets SSD_A_NEW and SSD_B_NEW to the outputs of the SSD_Generation procedure.

Thereafter, the mobile station 101 selects a 32-bit random number, RANDBS, and sends it to the base station 105 in a Base Station Challenge Order message. The mobile station 101 and base station 105 execute an authorization signature (Auth_Signature) procedure to yield the Base Station Authentication Response (AUTHBBS). AUTHBS is, in an exemplary embodiment, an 18-bit pattern generated by the authentication algorithm, and is employed to confirm the validity of base station orders to update the Shared Secret Data. The Auth_Signature procedure is further detailed in the IS2000 Revision D standard, as incorporated herein.

The base station 105 sends its computed value of AUTHBS to the mobile station 101 in a Base station Challenge Confirmation Order message.

Upon receipt of the Base Station Challenge Confirmation Order, the mobile station 101 compares the received value of AUTHBS to an internally computed value. A successful comparison results in transmission of a SSD Update Confirmation Order message by the mobile station 101 to notify the base station 105 of the successful completion of the SSD update. However, if the mobile station 101 receives a Base Station Challenge Confirmation Order when an SSD update is not in progress, the mobile station 101 will respond with an SSD Update Rejection Order.

In step 303, the mobile station 101 and the base station 105 both generate a new CMEAKEY (Cellular Message Encryption Algorithm Key) using the newly acquired SSD and RANDBS (Random Variable Base Station) as input.

Next, the mobile station 101, as in step 305, generates a new crypto-sync: NEW_SSEQ_H and sends a Security Mode Request Message (SMRM) with this new crypto-sync. The Security Mode Request Message includes an Authentication Response (AUTHR) that is generated using the new SSD and RANDs from the overhead message. In an exemplary embodiment of the present invention, AUTHR is an 18-bit output of an authentication algorithm; such algorithm is detailed in S.S0053 v1.0, Common Cryptographic Algorithms (January 2002), which is incorporated herein by reference in its entirety. AUTHR is used, for example, to validate mobile station registrations, originations and terminations.

When base station 105 receives the Security Mode Request Message and verifies the AUTHR, the base station 105 commits to the new CMEAKEY and crypto-sync (i.e., NEW_SSEQ_H) received in the Security Mode Request Message. Subsequently, the base station 105 responds with a Security Mode Command Message to notify or instruct the mobile station 101 to commit to the new CMEAKEY and NEW_SSEQ_H. Upon receipt of this message, the mobile station 101 commits to the CMEAKEY and NEW_SSEQ_H. At the end of the procedure, a new set of encryption/integrity key based of newly generated SSD and new crypto-sync is established between the mobile station 101 and the base station 105.

The above process improves the efficiency of encryption/integrity key set-up upon completing the SSD update. For instance, in both idle and traffic state, the new key set-up is completed concurrently with the SSD update procedure, thereby avoiding starting another key set-up procedure to merely obtain new keys based of newly generated SSD, or waiting until the traffic ends to start the key set-up procedure.

Alternatively, set up of a new set of keys and crypto-sync based of the newly acquired SSD can be further integrated with the SSD update procedure, as explained below with respect to FIG. 4.

In the scenario of FIG. 4, the base station 105, per step 401, sends SSD Update Request initiating the SSD update procedure. This message is similar to that of step 301.

Upon receiving the SSD Update Request, the mobile station 101 performs the following. The mobile station 101 selects a RANDBS, and generates new CMEAKEY based of the new SSD and RANDBS. Additionally, the new crypto-sync, NEW_SSEQ_H, is generated. According to an embodiment of the present invention, the over the air interface message, Base Station Challenge Order, is modified to include the extra crypto-sync information. The mobile station 101 then sends, as in step 403, a Base Station Challenge Order with the generated RANDBS and NEW_SSEQ_H to the base station 105.

In step 405, upon receiving the Base Station Challenge Order, the base station 105 generates a new CMEAKEY based on the new SSD and RANDBS. The base station 105 stores the new crypto-sync: NEW_SSEQ_H. Additionally, the base station 105 calculates AUTHBS based on the new SSD and RANDBS. In response to the Base Station Challenge Order, the base station 105 sends a Base Station Challenge Confirmation Order specifying the AUTHBS to the mobile station 101.

In step 407, upon receiving the Base Station Challenge Confirmation Order, the mobile station 101 verifies the AUTHBS with a locally calculated AUTHBS. During this step, the mobile station 101 commits to the new CMEAKEY and crypto-sync (NEW_SSEQ_H). Thereafter, the mobile station 101 sends a SSD Update Confirmation Order to the base station 105, indicating successful update of the SSD.

At this point, in response to the SSD Update Confirmation Order, the base station 105 commits to the new CMEAKEY and stored NEW_SSEQ_H received in Base Station Challenge Order.

The processes described above advantageously provide efficient generation of new encryption/integrity keys during updating of the shared secret data. These processes can be executed through a variety of hardware and/or software configurations.

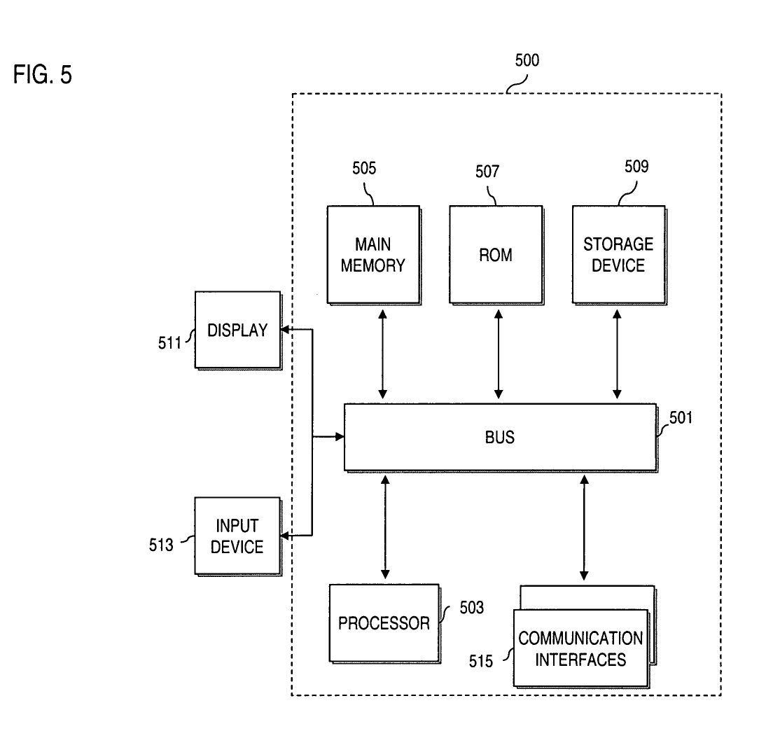

FIG. 5 illustrates exemplary hardware upon which an embodiment according to the present invention can be implemented. A computing system 500 includes a bus 501 or other communication mechanism for communicating information and a processor 503 coupled to the bus 501 for processing information. The computing system 500 also includes main memory 505, such as a random access memory (RAM) or other dynamic storage device, coupled to the bus 501 for storing information and instructions to be executed by the processor 503. Main memory 505 can also be used for storing temporary variables or other intermediate information during execution of instructions by the processor 503. The computing system 500 may further include a read only memory (ROM) 507 or other static storage device coupled to the bus 501 for storing static information and instructions for the processor 503. A storage device 509, such as a magnetic disk or optical disk, is coupled to the bus 501 for persistently storing information and instructions.

The computing system 500 may be coupled via the bus 501 to a display 511, such as a liquid crystal display, or active matrix display, for displaying information to a user. An input device 513, such as a keyboard including alphanumeric and other keys, may be coupled to the bus 501 for communicating information and command selections to the processor 503. The input device 513 can include a cursor control, such as a mouse, a trackball, or cursor direction keys, for communicating direction information and command selections to the processor 503 and for controlling cursor movement on the display 511.

According to one embodiment of the invention, the processes of FIGS. 2-4 can be provided by the computing system 500 in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement the embodiment of the present invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the present invention are not limited to any specific combination of hardware circuitry and software.

The computing system 500 also includes at least one communication interface 515 coupled to bus 501. The communication interface 515 provides a two-way data communication coupling to a network link (not shown). The communication interface 515 sends and receives electrical, electromagnetic, or optical signals that carry digital data streams representing various types of information. Further, the communication interface 515 can include peripheral interface devices, such as a Universal Serial Bus (USB) interface, a PCMCIA (Personal Computer Memory Card International Association) interface, etc.

The processor 503 may execute the transmitted code while being received and/or store the code in the storage device 509, or other non-volatile storage for later execution. In this manner, the computing system 500 may obtain application code in the form of a carrier wave.

The term “computer-readable medium” as used herein refers to any medium that participates in providing instructions to the processor 503 for execution. Such a medium may take many forms, including but not limited to non-volatile media, volatile media, and transmission media. Non-volatile media include, for example, optical or magnetic disks, such as the storage device 509. Volatile media include dynamic memory, such as main memory 505. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the present invention has been described in connection with a number of embodiments and implementations, the present invention is not so limited but covers various obvious modifications and equivalent arrangements, which fall within the purview of the appended claims.

What is claimed is:

1. A method for providing communication signaling, the method comprising:
initiating update of shared secret data with a mobile station;
receiving, from the mobile station, a random value associated with authentication of the mobile station;
generating a key based on the updated shared secret data and the random value; and
performing set-up of the key and crypto-sync exchange with the mobile station.

2. A method according to claim 1, wherein the mobile station operates within a spread spectrum system.

3. A method according to claim 1, wherein the mobile station operates in an idle state or a traffic state.

4. A method according to claim 1, wherein the mobile station generates an authentication response (AUTHR) based on the updated shared secret data, the method further comprising:
receiving a security mode request message specifying the authentication response and a crypto-sync from the mobile station;
verifying the authentication response generated by the mobile station;
committing to the key and the crypto-sync; and
transmitting a security mode command message instructing the mobile station to commit to the key and the crypto-sync in response to the security mode request message.

5. A method according to claim 1, further comprising:
receiving a base station challenge message specifying the random value and a crypto-sync from the mobile station; and
in response to the received base station challenge message, transmitting a base station challenge confirmation message specifying an authorization response value to confirm validity of the update of the shared secret data.

6. A method according to claim 5, wherein the mobile station commits to the key and the crypto-sync, the method further comprising:
receiving a shared secret data confirmation order message providing notification of the commitment by the mobile station; and
committing to the key and the crypto-sync.

7. A computer-readable medium bearing instructions providing communication signaling, said instructions, being arranged, upon execution, to cause one or more processors to perform the method of claim 1.

8. An apparatus for providing communication signaling, the apparatus comprising:
means for initiating update of shared secret data with a mobile station;
means for receiving, from the mobile station, a random value associated with authentication of the mobile station;
means for generating a key based on the updated shared secret data and the random value; and
means for performing set-up of the key and crypto-sync exchange with the mobile station.

9. An apparatus according to claim 8, wherein the mobile station operates within a spread spectrum system.

10. An apparatus according to claim 8, wherein the mobile station operates in an idle state or a traffic state.

11. An apparatus according to claim 8, wherein the mobile station generates an authentication response (AUTHR) based on the updated shared secret data, the apparatus further comprising:
means for receiving a security mode request message specifying the authentication response and a crypto-sync from the mobile station;
means for verifying the authentication response generated by the mobile station;
means for committing to the key and the crypto-sync; and
means for transmitting a security mode command message instructing the mobile station to commit to the key and the crypto-sync in response to the security mode request message.

12. An apparatus according to claim 8, further comprising:
means for receiving a base station challenge message specifying the random value and a crypto-sync from the mobile station; and
means for transmitting, in response to the received base station challenge message, a base station challenge confirmation message specifying an authorization response value to confirm validity of the update of the shared secret data.

13. An apparatus according to claim 12, wherein the mobile station commits to the key and the crypto-sync, the apparatus further comprising:
receiving a shared secret data confirmation order message providing notification of the commitment by the mobile station; and
committing to the key and the crypto-sync.

14. A method for providing communication signaling, the method comprising:
receiving a request from a base station for updating of shared secret data;
transmitting a random value for authentication to the base station;
generating a key based on the updated shared secret data and the random value; and performing set-up of the key and crypto-sync exchange with the base station.

15. A method according to claim 14, wherein the base station operates within a spread spectrum system.

16. A method according to claim 14, further comprising:
operating in an idle state or a traffic state during receipt of the request for updating of the shared secret data.

17. A method according to claim 14, further comprising:
generating an authentication response based on the updated shared secret data, wherein the authentication response supports validation of registration;
generating a security mode request message specifying the authentication response and a crypto-sync;
transmitting the security mode request message to the base station, wherein the base station verifies the authentication response generated by the mobile station and commits to the key and the crypto-sync; and
receiving a security mode command message instructing commitment to the key and the crypto-sync in response to the security mode request message.

18. A method according to claim 14, further comprising:
transmitting a base station challenge message specifying the random value and a crypto-sync from the mobile station; and
receiving, in response to the base station challenge message, a base station challenge confirmation message specifying an authorization response value to confirm validity of the update of the shared secret data.

19. A method according to claim 18, further comprising:
committing to the key and the crypto-sync; and
transmitting a shared secret data confirmation order providing notification of the commitment to the base station, wherein the base station commits to the key and the crypto-sync.

20. A computer-readable medium bearing instructions providing communication signaling, said instructions, being arranged, upon execution, to cause one or more processors to perform the method of claim 14.

21. An apparatus for providing communication signaling, the apparatus comprising:
means for receiving a request from a base station for updating of shared secret data;
means for transmitting a random value for authentication to the base station;
means for generating a key based on the updated shared secret data and the random value; and
means for performing set-up of the key and crypto-sync exchange with the base station.

22. An apparatus according to claim 21, wherein the base station operates within a spread spectrum system.

23. An apparatus according to claim 21, further comprising:
means for operating in an idle state or a traffic state during receipt of the request for updating of the shared secret data.

24. An apparatus according to claim 21, further comprising:
means for generating an authentication response based on the updated shared secret data, wherein the authentication response supports validation of registration;
means for generating a security mode request message specifying the authentication response and a crypto-sync;
means for transmitting the security mode request message to the base station, wherein the base station verifies the authentication response generated by the mobile station and commits to the key and the crypto-sync; and
means for receiving a security mode command message instructing commitment to the key and the crypto-sync in response to the security mode request message.

25. An apparatus according to claim 21, further comprising:
means for transmitting a base station challenge message specifying the random value and a crypto-sync from the mobile station; and
means for receiving, in response to the base station challenge message, a base station challenge confirmation message specifying an authorization response value to confirm validity of the update of the shared secret data.

26. An apparatus according to claim 25, further comprising:
means for committing to the key and the crypto-sync; and
means for transmitting a shared secret data confirmation order providing notification of the commitment to the base station, wherein the base station commits to the key and the crypto-sync.

27. A method of providing secure communications, the method comprising:
communicating with a base station to update shared secret data (SSD), the communicating step includes,
receiving a SSD update message from the base station,
transmitting a base station challenge order to the base station,
receiving a base station challenge confirmation order from the base station, and
transmitting a SSD update confirmation order to the base station;
generating a cellular message encryption algorithm key (CMEAKEY) based on the updated shared secret data and a base station random variable (RANDBS), wherein the base station generates the CMEAKEY based on the updated shared secret data and the RANDBS, the RANDBS being conveyed by the base station challenge order;
transmitting, to the base station, a security mode request message specifying a crypto-sync and an authentication response (AUTHR), wherein the base station verifies the authentication response generated by the mobile station and commits to the CMEAKEY and the crypto-sync; and
receiving a security mode command message instructing commitment to the CMEAKEY and the crypto-sync in response to the security mode request message.

28. A method according to claim 27, wherein the base station operates within a spread spectrum system.

29. A method of providing secure communications, the method comprising:
receiving a shared secret data (SSD) update message from a base station for updating of shared secret data;
selecting a base station random variable (RANDBS);
generating a cellular message encryption algorithm key (CMEAKEY) based on the updated shared secret data and the RANDBS;
transmitting to the base station a base station challenge order specifying the RANDBS and a crypto-sync to the base station, wherein the base station generates the CMEAKEY based on the updated shared secret data and the RANDBS;
receiving, in response to the base station challenge order, a base station challenge confirmation order specifying a base station authorization response (AUTHBS) to confirm validity of the update of the SSD;
committing to the CMEAKEY and the crypto-sync; and
transmitting an SSD update confirmation order to the base station to indicate successful update of the shared secret data, wherein the base station commits to the CMEAKEY and the crypto-sync.

30. A method according to claim 29, wherein the base station operates within a spread spectrum system.

31. A base station comprising:
a memory configured to store shared secret data;
a processor configured to initiate update of the shared secret data with a handset;
a communication interface coupled to the processor and configured to receive, from the handset, a random value associated with authentication of the handset,
wherein the processor is further configured to generate a key based on the updated shared secret data and the random value, the processor performing set-up of the key and crypto-sync exchange with the handset.

32. A base station according to claim 31, wherein the handset generates an authentication response (AUTHR) based on the updated shared secret data, the communication interface receiving a security mode request message specifying the authentication response and a crypto-sync from the handset, the processor being further configured to verify the authentication response generated by the handset and to commit to the key and the crypto-sync, wherein the communications interface transmits a security mode command message instructing the handset to commit to the key and the crypto-sync in response to the security mode request message.

33. A base station according to claim 31, wherein the communication interface receives a base station challenge message specifying the random value and a crypto-sync from the handset, and in response to the received base station challenge message, the communication interface transmitting a base station challenge confirmation message specifying an authorization response value to confirm validity of the update of the shared secret data, the handset committing to the key and the crypto-sync, the communication interface receiving a shared secret data confirmation order message providing notification of the commitment by the handset, the processor committing to the key and the crypto-sync.

34. A handset comprising:
a memory configured to store shared secret data;
a communication interface configured to receive a request from a base station for updating of the shared secret data; and
a processor configured to generate a random value for authentication, wherein the communication interface transmits the random value to the base station, the processor generating a key based on the updated shared secret data and the random value, and performing set-up of the key and crypto-sync exchange with the base station.

35. A handset according to claim 34, wherein the processor is further configured to generate an authentication response based on the updated shared secret data, wherein the authentication response supports validation of registration, the communication interface transmitting a security mode request message specifying the authentication response and a crypto-sync to the base station, wherein the base station verifies the authentication response generated by the mobile station and commits to the key and the crypto-sync, the communication interface receiving a security mode command message instructing commitment to the key and the crypto-sync in response to the security mode request message.

36. A handset according to claim 34, wherein the communication interface transmits a base station challenge message specifying the random value and a crypto-sync from the mobile station, the communication interface receiving, in response to the base station challenge message, a base station challenge confirmation message specifying an authorization response value to confirm validity of the update of the shared secret data, wherein the processor commits to the key and the crypto-sync, and the communication interface transmits a shared secret data confirmation order providing notification of the commitment to the base station, the base station committing to the key and the crypto-sync.
